(19) United States
(12) Patent Application Publication
(10) Pub. No.: US 2020/0346946 A1
(43) Pub. Date: Nov. 5, 2020

(54) Water Filter

(71) Applicant: Daren Scott Kernodle, Las Vegas, NV (US)

(72) Inventor: Daren Scott Kernodle, Las Vegas, NV (US)

(21) Appl. No.: 16/403,291

(22) Filed: May 3, 2019

(51) Int. Cl. C02F 1/28; C02F 1/467

(52) U.S. Cl. CPC C02F 1/283; C02F 2101/22; C02F 1/467

(57) ABSTRACT

A water filter includes a central rod, a first filtration element attached to the central rod, a second filtration element comprising a plurality of filtration rods each having a first end and a second end, a first end of the filtration rods attached to the central rod, the filtration rods disposed to surround the first filtration element, a third filtration element being a mesh filtration element, the mesh filtration element being attached to each of the filtration rods, and extenders attached to the filtration rods, the extenders being configured to move the filtration rods between a closed position and an open position.

### FIELD OF THE INVENTION

The present invention relates to a water filter for removing contaminants from water. In particular, the present invention relates to a floating water filter for in-container use.

### BACKGROUND OF THE INVENTION

Many methods and apparatus have been developed for removing contaminants from water to provide safe drinking water for human use. The contaminants in water may include any physical, chemical, biological, or radiological substance or matter in water. Physical contaminants primarily impact the physical appearance or other physical properties of water. Examples of physical contaminants are sediment or organic material. Chemical contaminants are elements or compounds. These contaminants may be naturally occurring or man-made. Examples of chemical contaminants include nitrogen, bleach, salts, pesticides, metals, toxins produced by bacteria, and human or animal drugs. Biological contaminants are organisms in water. They are also referred to as microbes or microbiological contaminants. Examples of biological or microbial contaminants include bacteria, viruses, protozoan, and parasites. Radiological contaminants are chemical elements with an unbalanced number of protons and neutrons resulting in unstable atoms that can emit ionizing radiation. Examples of radiological contaminants include cesium, plutonium and uranium.

Drinking water may reasonably be expected to contain at least small amounts of some contaminants. Some drinking water contaminants may be harmful if consumed at certain levels in drinking water while others may be harmless. The presence of contaminants does not necessarily indicate that the water poses a health risk.

Accordingly, an improved water filter is desired.

### SUMMARY OF THE INVENTION

Embodiments of the invention comprise a water filter including a central rod, a first filtration element attached to the central rod, a second filtration element comprising a plurality of filtration rods each having a first end and a second end, a first end of the filtration rods attached to the central rod, the filtration rods disposed to surround the first filtration element, a third filtration element being a mesh filtration element, the mesh filtration element being attached to each of the filtration rods, and extenders attached to the filtration rods, the extenders being configured to move the filtration rods between a closed position and an open position.

In another embodiment, the invention comprises a water filter including an end knob configured to be gripped by a user, a carbon-based filtration element attached to the end knob, a redox filtration element comprising a plurality of filtration rods each having a first end and a second end, a first end of the filtration rods attached to the end knob, the filtration rods disposed to surround the carbon-based filtration element, and extenders attached to the filtration rods, the extenders being configured to move the filtration rods between a closed position and an open position to increase a filtration effect of the filter.

Further objects, features, and advantages of the present invention over the prior art will become apparent from the detailed description of the drawings which follows, when considered with the attached figures.

### DESCRIPTION OF THE DRAWINGS

FIG. 1 illustrates a water filter in a closed position in accordance with embodiments of the invention.

FIG. 2 illustrates a water filter in an open position in accordance with embodiments of the invention.

FIG. 3 illustrates a water filter in an open position in accordance with embodiments of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise a water filter having up to three types of filtration. The water filter is configured to be used in water containers, such as glasses, pots, or any other water container. The water filter can be used in a standard water glass, a cooking pot, as an inline filter, and for larger bodies of water such a birthing pool to remove impurities in the water to help protect newborns from heavy metals and chemicals when birthed, a swimming pool, etc.

As described in more detail below, the water filter uses up to three types of on-contact filtration to rid the water of impurities. Two of the three types of filtration are Kinetic Degradation Fluxion (KDF), in particular KDF-55 and KDF-85. KDF is a high purity alloy formulation of copper and zinc. It uses a process of electrochemical oxidation-reduction, also known as Redox Potential. Redox is an exchange of electrons with contaminants in the water, which alters the contaminants to become harmless. Substances with positive charges are attracted to the negative charge of zinc, while substances with a negative charge are attracted to the positive charge of copper.

KDF is used in water filters to remove chlorine, mercury, iron, magnesium, hydrogen sulfide, chromium, and some heavy metals like lead, arsenic, aluminum, mercury and cadmium. It also has a mild anti-bacterial, algaecide and fungicide effect.

KDF works on contact so there is nothing more to do than introduce this material to the molecules of dissolved impurities within the water. Two kinds of KDF may be used in embodiments of the invention because KDF-55 and KDF-85 target different contaminants. KDF-55 is for removing/reducing chlorine and heavy metals, while KDF-85 is for removing/reducing chloramines, iron and hydrogen sulfide, for example.

Embodiments of the invention also use an interior Activated Carbon Block filter. Using activated carbon to treat water has been around since at least the mid 20^{th} century. Like KDF, activated carbon works on contact without the use of chemicals. Activated carbon can remove 81 different chemicals and is effective at reducing another 52 chemicals. It is the only known filtering material that removes 14 pesticides and 32 identified organic contaminants.

In one preferred embodiment, the activated carbon filter may be an extremely dense, micro-porous surface area, that removes impurities and contaminants through “adsorption”. Adsorption is the process of a gaseous liquid or dissolved solid substance attaching them to a surface and creating a film on the substance. As impure water passes over the surface area of the activated carbon, the contaminants are captured and held within its cavities.

The amazing thing about activated carbon is its sheer monumental amount of surface area. One pound of activated carbon contains roughly 125 acres of surface area. It is estimated that just one gram has about 32,000 square feet and a lowly teaspoon can house an entire football field. At a microscopic level, all of these little nooks and crannies together become pockets of impurities that do not belong in the water.

There are a few reasons that coconut shell is chosen as the specific type of carbon to be used. The first is because of its vast numbers of micro-pores. Other types of carbon can be used to treat water, but different materials offer different sized pores, which means that they will filter different things. In the microscopic world of molecules, there are macro-pores, meso-pores and micro-pores. In regards to measurement, these pores are all sized in nanometers. Respectively, macro-pores are the largest, ranging from 50 to 2,000 nanometers. Meso-pores are anywhere from 2-50 nanometers, while micro-pores are less than 2 nanometers. Micro-pores in coconut shell-based carbon are far more effective in filtering than any other known form of activated carbon. Accordingly, embodiments of the present invention use micro-pore activated carbon for cleansing the water of contaminants and volatile organic chemicals (VOCs).

The second benefit of the coconut shell-based carbon is it is the best form of activated carbon for taste of the water. Other forms of activated carbon like charcoal can remove the taste and odor of chlorine, but tend to leave behind its own distinctive taste due to inorganic ash. Coconut shell-based carbon's inorganic ash count is relatively low in comparison and thus it does not leave behind any detectable taste of its own in the filtered water. Coconut shell-based carbon creates the cleanest water of any activated carbon.

Additionally, coconut shell-based carbon is a renewable source in that coconuts can be harvested from the same tree repeatedly without causing harm to the tree. Also, the coconuts can be preserved for years if needed and therefore are more readily available. Unlike charcoal or wood based carbon filters, coconuts do not harm the environment the way mining and lumber industries have.

By using three types of filtration, embodiments of the invention can produce superior filtration as compared to previous water filters not using the three types of filtration.

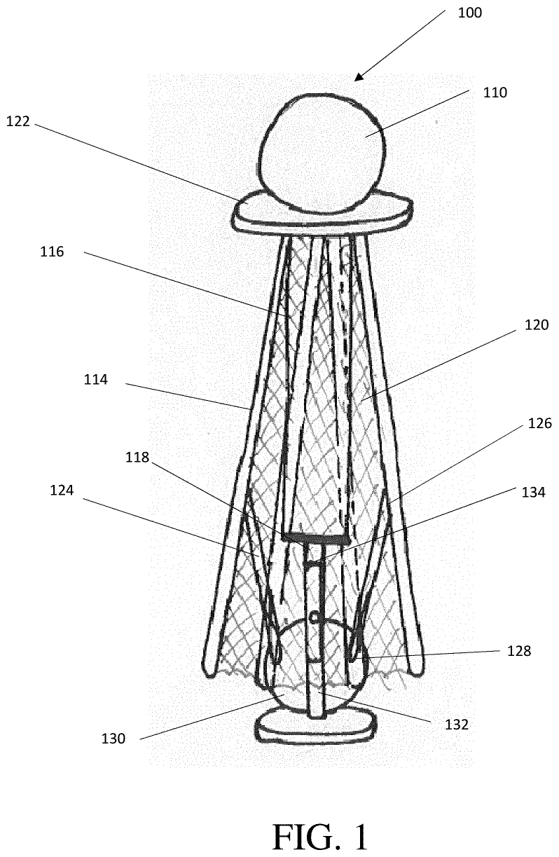

As shown in FIG. 1, embodiments of the water filter 100 include a stirring handle or knob 110, rods 114 extending downward from the knob 110, a filter 116 surrounded by the rods 114 and extending downward from the knob 110, a central rod 118 connecting to the knob 110 and supporting the filter 116, a mesh filter 120 connected to and surrounding the rods 114, and a base 122. As shown in the figures, there may be two bases 122, one base 122 at each end of the central rod 118. In some embodiments, the mesh filter 120 may be omitted.

The stirring handle or knob 110 is configured to be easily gripped by a human hand, and to cause the water filter 100 to float in water. This is accomplished by making the knob 110 from a material and of a size sufficient to prevent the water filter 100 from sinking when placed in water. For example, the knob 110 could be made from cork, wood, Styrofoam or other materials with less density than water.

In one embodiment, the filter 116 may be an activated carbon filter. The activated carbon filter uses activated carbon to remove contaminants and impurities using chemical adsorption. As described above, the activated carbon filter 116 may have an extremely dense, micro-porous surface area, that removes impurities and contaminants through “adsorption”. As impure water passes over the surface area of the activated carbon, the contaminants are captured and held within its cavities. Furthermore, in preferred embodiments, the activated carbon filter 116 may comprise coconut shell-based carbon as described above.

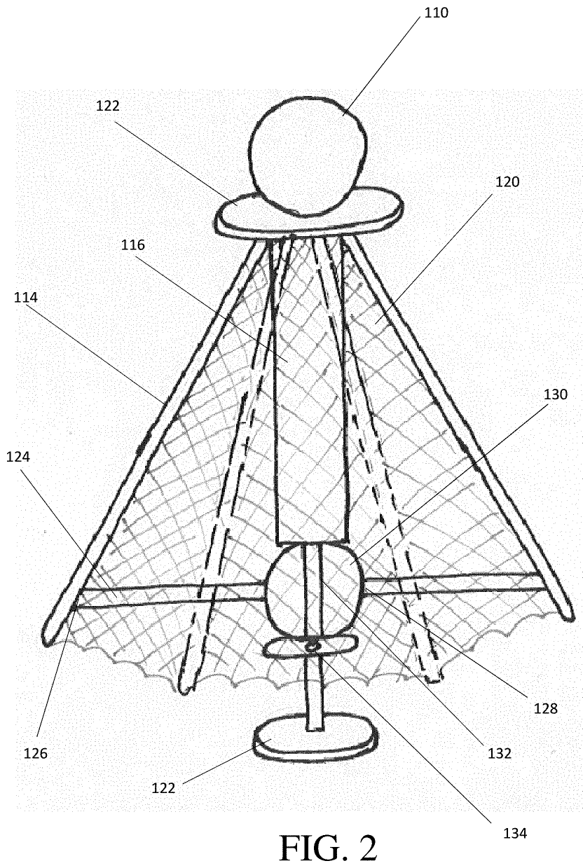

In embodiments, the rods 114 may be KDF-85 rods. There may be eight rods 114, although a different number of rods could be used. The rods 114 are configured to be movable from a closed position as illustrated in FIG. 1, to an open position as illustrated in FIG. 2. The rods 114 may be moved from the closed position to the open position by extenders 124. The extenders 124 may also be KDF-85. The rods 114 may be connected to the knob 110 or to the central rod 118.

The extenders 124 are connected at their outer ends 126 to the rods 114, and are connected at their inner ends 128 to locking mechanism 130. When the locking mechanism 130 is pushed upward by a user from the position shown in FIG. 1, it raises the inner ends 128 of the extenders 124, pushing the rods 114 outward to the open position of FIG. 2. The locking mechanism 130 may be locked in the open position.

The mesh filter 120 is attached to an outer portion of the rods 114 such that when the rods 114 are moved from the closed position to the open position, the mesh filter 120 will move with the rods 114. The mesh filter 120 may be KDF-55 for removing chlorine and heavy metals from the water. When the filter is in the closed position of FIG. 1. The mesh filter 120 hangs loosely from the rods 114, with extra mesh material between the rods 114, so that when the filter is moved to the open position, there is sufficient mesh material to move with the rods 114 to the open position.

The locking mechanism 130 may include a slot 132 that can receive central rod 118. A user can grasp the knob 110 with one hand, and grasp the locking mechanism 130 with the other hand and move the locking mechanism 130 upwards by sliding the slot 132 along the central rod 118, pushing the inner ends 128 of the extenders 124 higher, causing the outer ends of the extenders 124 and the rods 114 to move outward. The locking mechanism 130 and/or the central rod includes structure to lock the locking mechanism 130 in the open position. For example, the central rod 118 may include a notch at 134 that passes through slot 132 and twists to lock in a horizontal position and suspend locking mechanism 130 adjacent thereto.

When the water filter 100 is moved from the closed position to the open position, the rods 114 with KDF-85 and the mesh filter with KDF-55 are exposed to more water, increasing the effectiveness of the filter by exposing the filtration elements to more of the water molecules.

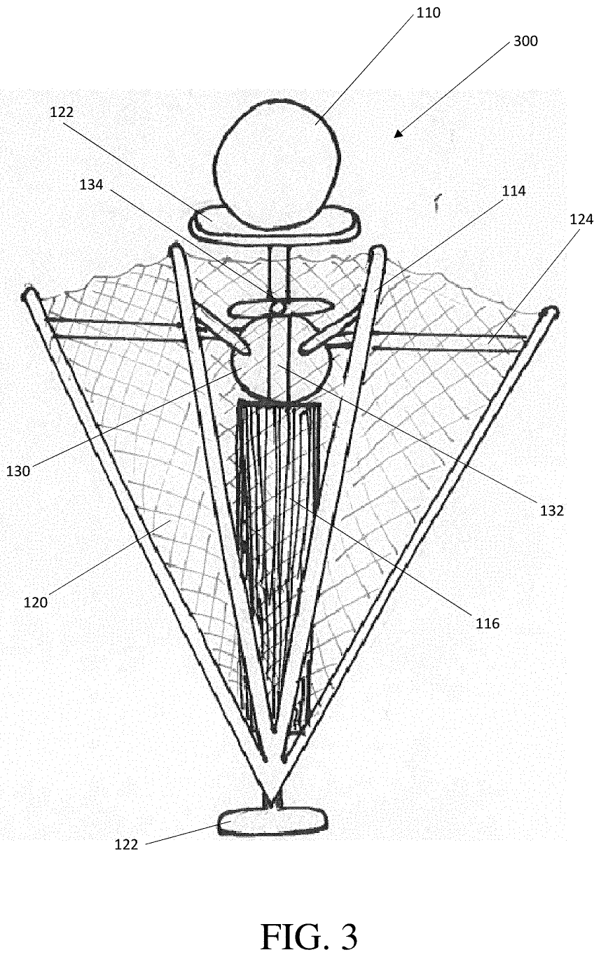

FIG. 3 illustrates an alternative embodiment of the invention in which the water filter 300 is inverted compared to the embodiment illustrated in FIGS. 1 and 2. In this instance, the knob 110 is disposed at the opposite end of the central rod 118, such that the rods 114 are attached to the central rod 118 (or to the base) at a bottom portion of the water filter 300. When the water filter is moved to the open position as shown in FIG. 3, the rods 114 move outward at a position close to the top of the water filter 300 as opposed to the embodiment of FIGS. 1 and 2.

Additional elements of the water filter 100 could be formed with KDF-85 or KDF-55, such as the central rod 118. Additionally, in any of the disclosed embodiments, the knob 110 can be used to stir the water filter 100, 300 in the water to increase the effect of the filters.

Although the filtration elements are described herein as KDF55, KDF-88 and activated carbon, other types of filtration could be used with embodiments of the invention to provide different filtration effects.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A water filter apparatus comprising:
a central rod;
a first filtration element attached to the central rod;
a second filtration element comprising a plurality of filtration rods each having a first end and a second end, a first end of the filtration rods attached to the central rod, the filtration rods disposed to surround the first filtration element;
a third filtration element being a mesh filtration element, the mesh filtration element being attached to each of the filtration rods; and
extenders attached to the filtration rods, the extenders being configured to move the filtration rods between a closed position and an open position to increase a filtration effect of the filter.

2. The water filter of claim 1, wherein the first filtration element is an activated carbon filter.

3. The water filter of claim 1, wherein the second filtration element is a KDF-85 filtration element.

4. The water filter of claim 1, wherein the third filtration element is a KDF-55 mesh filtration element.

5. The water filter of claim 1, wherein the extenders are configured to push the second end of the filtration rods to a position farther from the central rod when in the open position as compared to the closed position.

6. The water filter of claim 1, further comprising a locking mechanism configured to lock the filtration rods in the open position.

7. The water filter of claim 6, wherein the locking mechanism includes a slot configured to receive the central rod therein.

8. The water filter of claim 1, further comprising a stirring knob disposed at an end of the central rod, the stirring knob being configured to be gripped by a user to stir the water filter in a water container.

9. The water filter of claim 8, wherein the stirring knob is formed from a material that causes the water filter to float when placed in water.

10. A water filter comprising:
an end knob configured to be gripped by a user;
a carbon-based filtration element attached to the end knob;
a redox filtration element comprising a plurality of filtration rods each having a first end and a second end, a first end of the filtration rods attached to the end knob, the filtration rods disposed to surround the carbon-based filtration element; and
extenders attached to the filtration rods, the extenders being configured to move the filtration rods between a closed position and an open position to increase a filtration effect of the filter.

11. The water filter of claim 10, further comprising a mesh filtration element, the mesh filtration element being attached to each of the filtration rods.

12. The water filter of claim 10, wherein the carbon-based filtration element is an activated carbon filter.

13. The water filter of claim 10, wherein the redox filtration element is a KDF-85 filtration element.

14. The water filter of claim 11, wherein the mesh filtration element is a KDF-55 mesh filtration element.

15. The water filter of claim 10, wherein the extenders are configured to push the second end of the filtration rods to a position farther from the carbon-based filtration element when in the open position as compared to the closed position.

16. The water filter of claim 10, further comprising a locking mechanism configured to lock the filtration rods in the open position.

17. The water filter of claim 10, wherein the end knob comprises a stirring knob configured to be gripped by a user to stir the water filter in a water container.

18. The water filter of claim 17, wherein the stirring knob is formed from a material that causes the water filter to float when placed in water.
